(19) United States
(12) Patent Application Publication
(10) Pub. No.: US 2007/0073699 A1
(43) Pub. Date: Mar. 29, 2007

(54) IDENTITY MANAGEMENT SYSTEM FOR MANAGING ACCESS TO RESOURCES

(75) Inventor: Dana A. Reed, Grand Ledge, MI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aegis Business Group, Inc., Greenwood Village, CO (US)

(21) Appl. No.: 11/535,409

(22) Filed: Sep. 26, 2006

Related U.S. Application Data
(60) Provisional application No. 60/720,829, filed on Sep. 26, 2005.

(51) Int. Cl. G06F 17/30

(52) U.S. Cl. 707/9

(57) ABSTRACT

An enterprise network has a plurality of applications or resources and an identity management (IDM) system for provisioning of users at those resources. The IDM system uses handlers and rules libraries for provisioning. The handlers organize provisioning tasks that are common to all the resources. The rules libraries have a library for each resource, within each library a rule set for each handler, and within each rule set a rule subset for each provisioning transaction type. Any number of different transactions types are permitted, such create a new employee account, terminate an account, disable an account, and create a new contractor account.

### CROSS-REFERENCES TO RELATED APPLICATIONS

This application claims priority to Provisional Application Number 60/720,829, filed Sep. 26, 2005, which is hereby incorporated by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

Identity management (IDM) systems perform, among other things, various functions relating to provisioning (adding, deleting and modifying) computer rights/access, often across multiple computers, databases, applications and similar resources in computerized environments. Establishing and maintaining user access and rights to resources can be complex when an enterprise or organization has a large number of resources and where the rights to any resource will vary depending upon the user. Some organizations may have hundreds of resources and thousands of employees. The nature of the resources will depend on the organization, and often are diverse, including employee databases, accounting systems (accounts payable, accounts receivable, etc.), email systems, document management systems, product databases, and so forth. An individual user's need to access a specific resource will not only depend on the nature of that resource, but also the requirements of the organization and the responsibilities of the individual user. The scope of access (e.g., unlimited, read only, etc.) may also vary depending on the user and the resource.

Existing identity management systems have provisioning or access management programs that are often provided “out-of-the-box” with each resource or application. Thus, a typical provisioning module for an application may have standard provisioning functions such as create user, enable user, disable user, delete user, and update user, but a business or enterprise will often need to modify or augment each of those functions to be consistent with its own internal business processes, such as requirements for approvals before establishing access rights (by management or other personnel), and for email and other notifications that need to be sent when rights are changed. When this is done in an environment with, say, hundreds of applications and thousands of users, an identity management system performing provisioning functions can become very complex, difficult to design, and costly to maintain, especially if the resources within the enterprise change or if business rules concerning access change.

### BRIEF SUMMARY OF THE INVENTION

Embodiments of the present invention provide identity management systems and methods for provisioning (managing access to) resources in a computerized environment, including handlers for performing basic provisioning functions/tasks common to the resources, and rules libraries providing rules and logic applicable to specific resources. The handlers and rules libraries operate together to provide a less complex identity management/ provisioning system, which is more efficiently designed and more easily maintained.

In one embodiment, an identity management system includes a processor for performing access management (provisioning) transactions, a memory device, and handlers and rules libraries stored in the memory device. Each handler has one or more handler tasks common to each of the system resources when provisioning. Each rules library corresponds to one resource and has rules to be used with the handler tasks. The processor executes a provisioning transaction for a resource by accessing each handler, accessing the rules library corresponding to that resource, and executing handler tasks using rules in the library associated with a transaction type corresponding to the provisioning transaction.

### BRIEF DESCRIPTION OF THE DRAWINGS

FIGS. 1 illustrates an identity management system in a network having multiple resources/applications and multiple users.

FIG. 2 illustrates several of the processing and major data components of an identity management system according to one embodiment of the invention.

FIG. 3 illustrates in greater detail the handlers and rules libraries used by the identity management system of FIG. 2, including the details of one of the rules libraries.

FIG. 4 is a general flow diagram of the operation of an identity management system using handlers and rules libraries, according to one embodiment of the invention.

FIG. 5 is a more detailed flow diagram of the operation of the identity management system.

FIG. 6, consisting of FIGS. 6a through 6f collectively, illustrates the operation of each of the handlers.

FIG. 7, consisting of FIGS. 7a through 7f collectively, illustrates an example of provisioning a user in the identity management system of FIG. 2, using handlers and rules libraries, wherein a new employee is granted rights to two resources in the network of FIG. 1.

FIG. 8 is an example similar to FIG. 7e, illustrating the notification handler and rules library operation if an error occurred during provisioning for one application.

FIG. 9 is an example similar to FIG. 7a, illustrating the pre-processing handler and rules library operation, with the provisioning transaction being “terminate”.

A more complete understanding of the present invention may be derived by referring to the detailed description of the invention and to the claims, when considered in connection with the Figures.

### DETAILED DESCRIPTION OF THE INVENTION

There are various embodiments and configurations for implementing the present invention. Generally, the embodiments involve provisioning or managing access (e.g., adding, deleting, changing and updating user rights) for resources in a network. Provisioning is accomplished at an identity management (IDM) system. In one disclosed embodiment, the provisioning functions are performed using “handlers” and “rules libraries” that are stored at the IDM system. Handlers organize or define groups of tasks that are common to provisioning many or all of the resources in the network. The handlers in one disclosed embodiment are grouped and referred to as “pre-processing,” “approval,” “processing,” “post-processing,” “notification,” and “deferred task” handlers.

In that same disclosed embodiment, each of the rules libraries is associated with one of the resources, having in that library all the logic and rules needed to carry out (in conjunction with the handlers) the provisioning for that resource. Within each library, there are groups or sets of rules, with each set dedicated to the tasks of one handler. And finally, within each such set of rules (dedicated to a handler), there are further groups or subsets of rules, with each subset of rules dedicated to a specific transaction (e.g., within a single rules library, there may be one subset of rules for creating a new employee user, one subset for creating a new non-employee user, one subset dedicated to disabling a user, one subset for deleting a user, and so forth).

The use of an IDM system having both handlers and rules libraries as just described permits simplification and efficiency in implementing and maintaining provisioning functions. As examples, if specific tasks (incorporated into a handler) need to be changed, the handler can be modified without modifying or reprogramming the provisioning logic or code embedded within an application, and without having to modify other handlers or the rules libraries. If an application is added or removed from the network, the rules library for that resource can be added or removed without affecting the handlers or affecting other rules libraries.

It should be appreciated that the terms “application” and “resource” are used interchangeably in this description to refer to all possible resources to which a user might need access within an enterprise. The terms include employee databases, accounting systems (accounts payable, accounts receivable, etc.), email systems, document management systems, product databases, and any other hardware and software-based systems and devices within the network.

It should be further appreciated that the term “provisioning” is used in its broadest sense to refer to all access management functions. Thus, provisioning refers not only to adding or providing a user with access to a resource, but also deleting a user, changing the scope of a user's access rights, as well as any other transactions affecting user access to a resource.

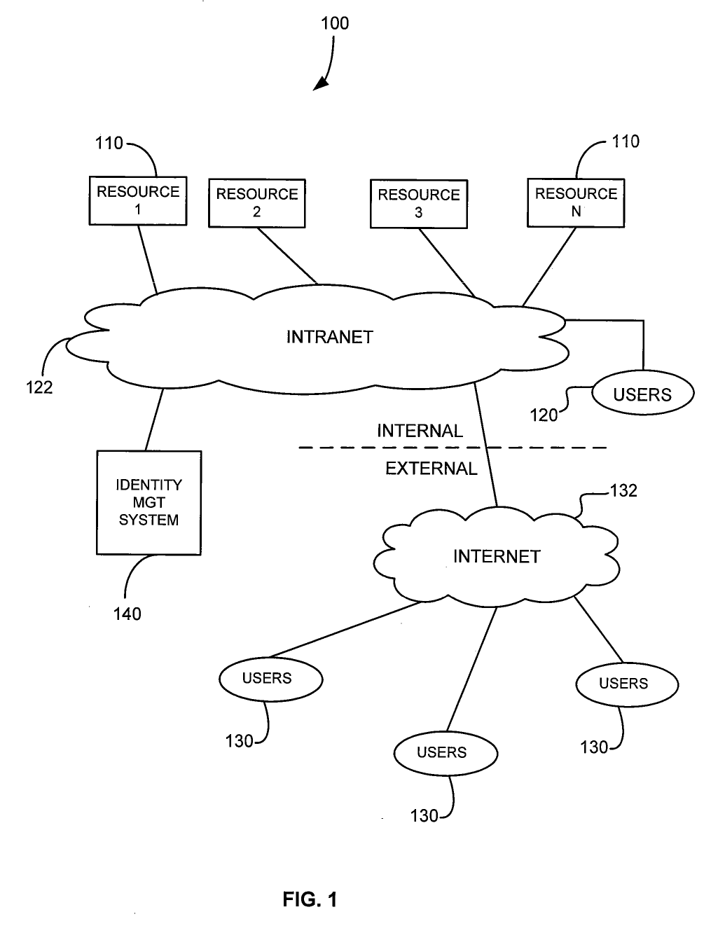

Referring now to the drawings, FIG. 1 illustrates a network 100 of an enterprise having multiple applications or resources 110 (Resource 1 through Resource N). The network has both internal users 120 and external users 130. The internal users may access the applications through, for example, an internal network (intranet) 122 and the external users may access the applications through an external network (Internet) 132. As one example, the internal users 120 may be employees of the enterprise, and the external users 130 may be contractors, customers, suppliers, and so forth. The enterprise's internal network includes a central identity management (IDM) system 140 that is used to establish and manage access rights to each of the applications 110, for both internal and external users.

Each application 110 may have conventional provisioning functions and logic (such as necessary for individually adding, deleting, changing and updating user rights for that particular application), however the IDM system 140, among other things, centralizes and controls the provisioning according to internal business rules and practices of the enterprise that operates network 100 (such rules and practices including, as examples, who gets access, who approves access, who gets notified of a change in access, and so forth).

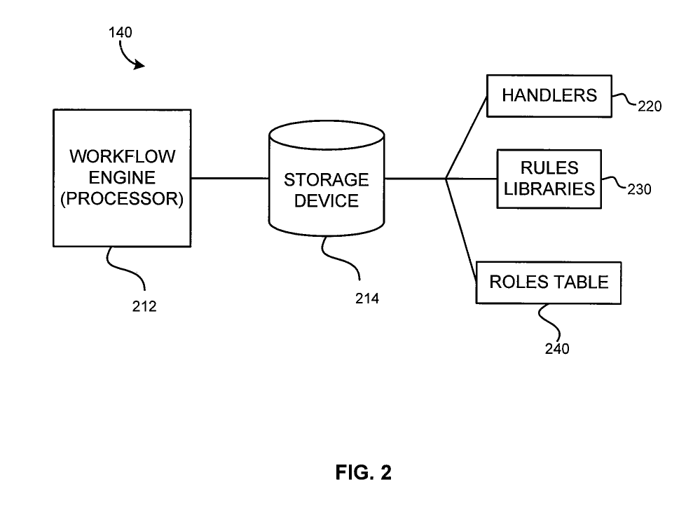

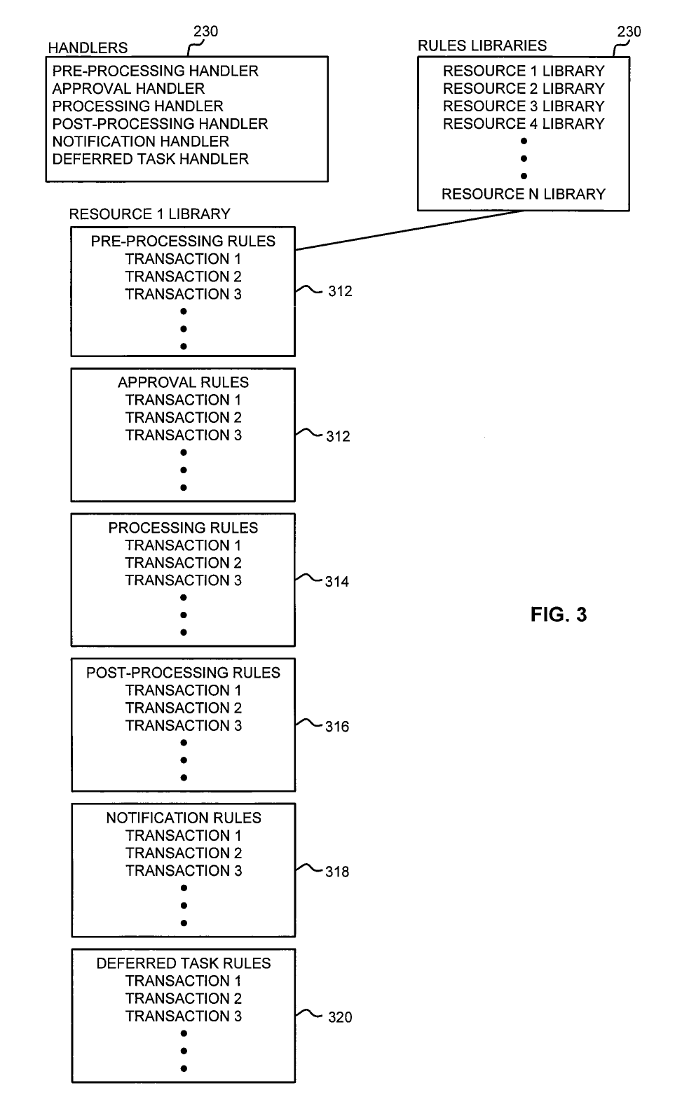

FIG. 2 shows the IDM system as including (among other things) a workflow engine processor 212 and a storage device 214. The workflow processor 212 executes programming code for controlling the provisioning process (as will be described in greater detail later). Such code and its logic may be stored at the device 214, and include a plurality of handlers 220 and a plurality of rules libraries 230. The handlers and rules libraries will be described in greater detail below in conjunction with FIG. 3 through 7.

The storage device also includes a roles table 240. This table specifies the resources to which individual users within the enterprise will have access. For example, an organization may stipulate, for each position within the company, the resources that a user will have access to, and the scope of that access. The table can be large for some organizations. As an example, an entry level employee may have access to only a limited number of company applications and databases, such as the general employee database, the company email system, a product database, etc., and may not have the ability to modify or write into or change any of those resources. As another example, a technical administrator may have read and write access to many or all of the applications/resources within that same company's systems. While the roles table 240 is illustrated as stored at IDM system 140, it could be stored elsewhere in the network as long as it is available to the IDM system when performing provisioning functions.

While the IDM system 140 is illustrated in simplified form as a single processor and a single storage device 214, it should be appreciated that IDM system 140 could include multiple computers, multiple processors, and multiple storage devices (located together or apart for collectively performing the functions of IDM system 140). Storage device 214 could be a hard disk drive, either integral with processor 212 or external to processor 212. Alternatively, device 214 could be a floppy disk or a CD-ROM apart from of processor 212 and accessible by inserting the device into a drive (not shown) of processor 212. In yet other alternatives, the storage device could be a RAM integral with processor 212. IDM system 140 will also have other conventional hardware and software components not shown, such as input devices, output devices, and so forth.

FIG. 3 illustrates in greater detail the structure of handlers 220 and rules libraries 230. As seen, the handlers 220 include a pre-processing handler, an approval handler, a processing handler, a post-processing handler, a notification handler, and a deferred task handler. As described earlier, the handlers 220 may be used across many applications and have code for organizing or performing specific tasks and processes that are common to provisioning those applications. The handlers are executed in the order shown in FIG. 3 for completing a provisioning function for a resource, and the tasks within each are generally determined by the order in which the handler falls. They are more fully described as follows:

Pre-processing handler—includes any tasks and processes that are to be performed prior to obtaining approval for provisioning. For example, if the provisioning is to add a new employee that will have access to an application, this handler would include the task of reserving a new user name for the employee, and placing the new user name in a table within IDM system 140. As another example, a new user may be required to log out of his workstation or system before provisioning can occur, and this handler may send a message to the user to log out during the provisioning process.

Approval Handler—includes any tasks and processes for obtaining approval for provisioning, such as the approval of a supervisor. For example, this handler may establish how emails are to be formatted when requesting approval, the confirmation of approval from reply emails, and so forth. As will be described later, in one embodiment, the rules libraries will provide logic, data, variables and other objects to the handler (determined by the application being provisioned), such as the specific recipient(s) to be used for an approval request emails, the content of the email subject line, and specific identifying information for the application and the access rights being requested (read only, unlimited access, etc.).

Processing Handler—includes any tasks and processes to be performed after obtaining approval, but before issuing a call, request or instruction to the application to provision the user. As an example, if a new user name has been reserved (using the pre-processing handler), a task in the processing handler would change the status of the user name from “reserved” to “active,” once the necessary approvals have been obtained. The handler would make the necessary status change in the user name table maintained by the IDM system, in order for the user to now have an active and unique user name that may be provided to the application in order to use that application.

Post-Processing Handler—includes any tasks and processes to be performed after actual provisioning for the application (i.e., after issuing a request or instruction to the application to provision the user). As an example, if the provisioning fails or has an error, this handler might create a report or message to the system administrator to review the error. As another example, if provisioning at an application is successful, this handler may be used to create a record of the provisioning so that the time, date and name of each application successfully provisioned is maintained for future use or audit.

Notification Handler—includes any tasks and processes to be performed in notifying parties of the provisioning. This handler will accumulate the notifications and, like the approval handler, may establish how emails are to be formatted and may obtain data and other objects from the rules libraries (based by the application being provisioned), such as the specific recipient(s) to be inserted into notifying emails, the content of the email subject line, and specific identifying information to be put in the notifying email identifying the application and the access rights granted (read only, unlimited access, etc.).

Deferred Task Handler—includes any tasks and processes to be performed after completion of the provisioning transaction at the application. As an example, if the provisioning transaction is creating a new contractor user, the deferred task handler may set a date of 180 days for the access to be automatically disabled (to assure there is no inadvertent, indefinite access by a non-employee to the application or resource). As another example, if the provisioning transaction is terminating an employee's access to an application, the deferred task handler may be programmed to merely disable the user account for a period of time, and then later (say, 180 days) have the user account completely deleted as a deferred task (e.g., in an email application, this task would permit a terminated user's emails to be received and reviewed by a system administrator for a period of time after the that user's access is disabled).

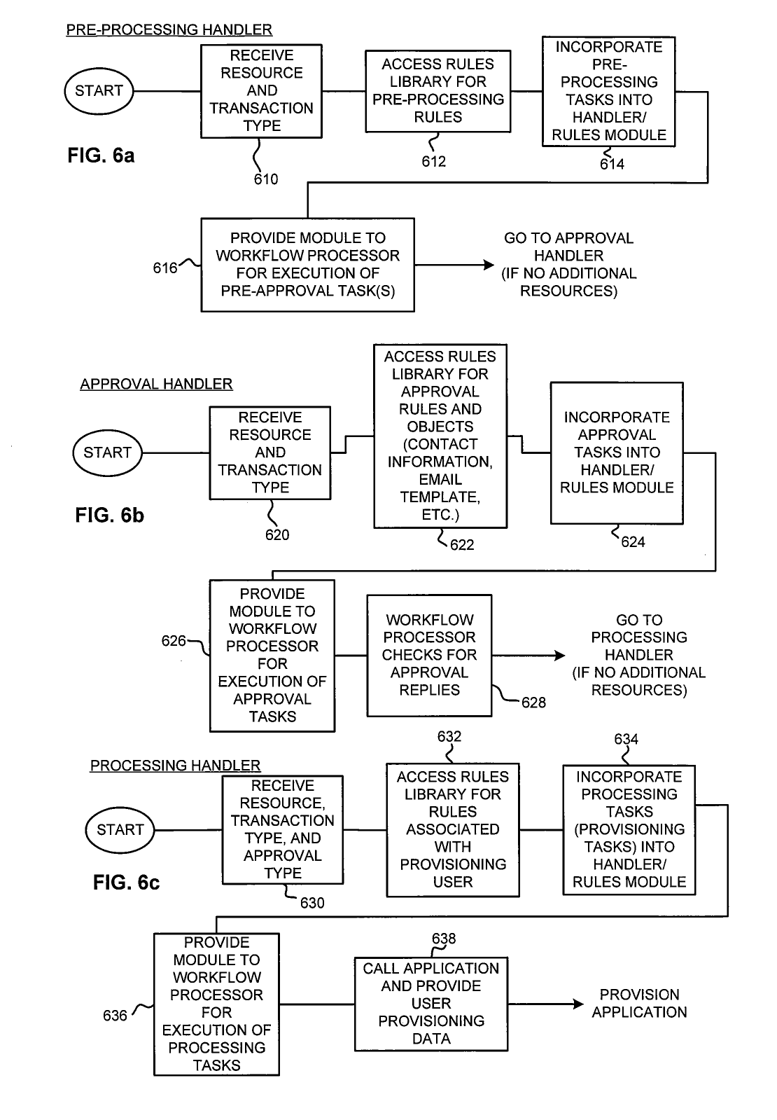

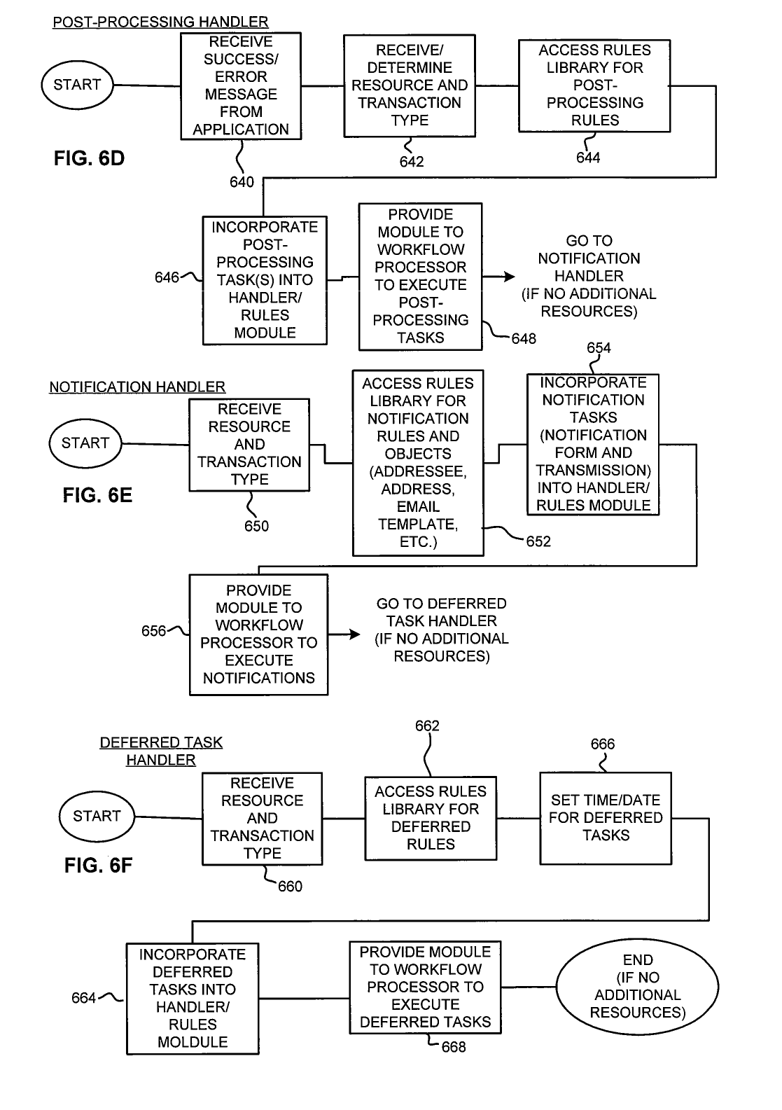

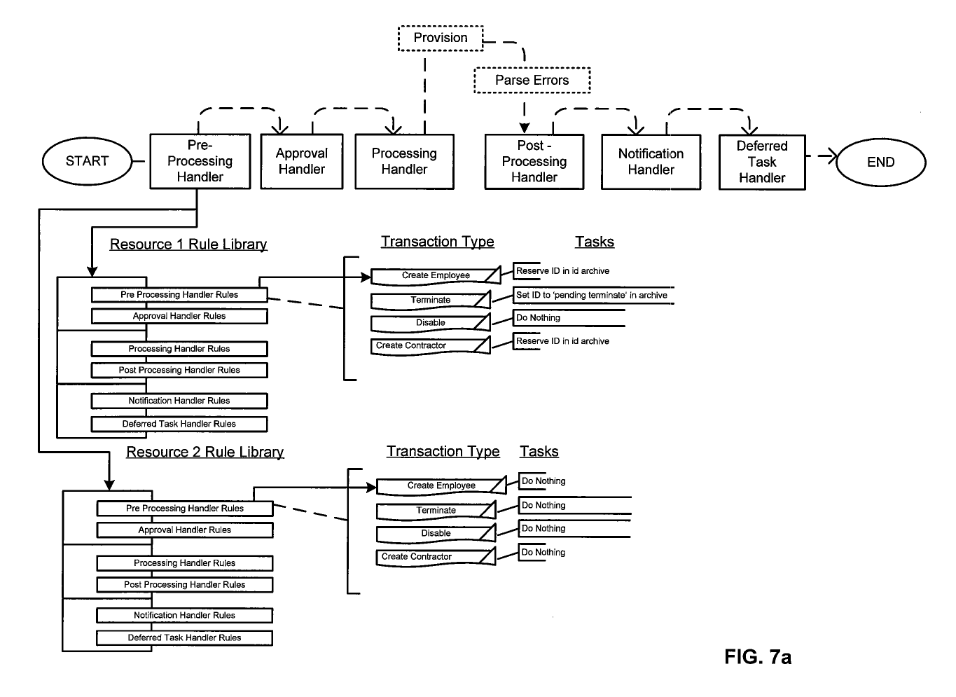

It should be appreciated that the examples given above as tasks under each handler are only illustrative. The tasks placed under any handler may vary according needs and practices of the enterprise. In one disclosed embodiment, tasks are placed or assigned to handlers based primarily on the order of the task's execution within the overall process. Depending on the application (and the rules in the rules library accessed by a given handler), there may be many, a few, or no tasks performed as part of the execution of such handler. A process flow for each handler is illustrated and will be described in greater detail later in conjunction with FIGS. 6a through 6f.

Referring still to FIG. 3, there is also illustrated the rules libraries 230. As mentioned earlier, each rules library will be associated with and correspond to one resource. Thus, in FIG. 3 there are many rules libraries (Resource 1 Library through Resource N Library), each of which corresponds to one resource or application (i.e., Resource 1 through Resource N, as seen in FIG. 1).

As further seen in FIG. 3, the rules in each rules library are organized in groups or rule sets (310 through 320) to correspond to handlers. Thus, under the illustrated rules library “Resource 1 Library,” there is a set of “pre-processing” rules corresponding to and used with the pre-processing handler (when provisioning Resource 1), a set of “approval” rules corresponding to and used with the approval handler (when provisioning Resource 1), a set of “processing” rules corresponding to and used with the processing handler (when provisioning Resource 1), and so forth. Similarly, for Resource 2 there is a similar set of rules corresponding to each handler (not illustrated in FIG. 3).

Finally, as also seen in FIG. 3, within each set of rules library (e.g., within each set of rules 310 through 320 illustrated in FIG. 3), there are further groups or rule subsets corresponding to each possible provisioning transaction (i.e., “Transaction 1,” “Transaction 2,” “Transaction 3,” etc.). As mentioned earlier, provisioning transactions may be “create employee access,” “create contractor access,” “disable access,” “terminate access,” as well as many others (depending on the provisioning functions needed by the enterprise). Thus, each of these provisioning transactions are represented by one of the rule subsets within each rules library. The specific rules, as mentioned earlier, provide logic and data (e.g., events, conditions, parameters, inputs or other variables) used with the handlers to carry out tasks.

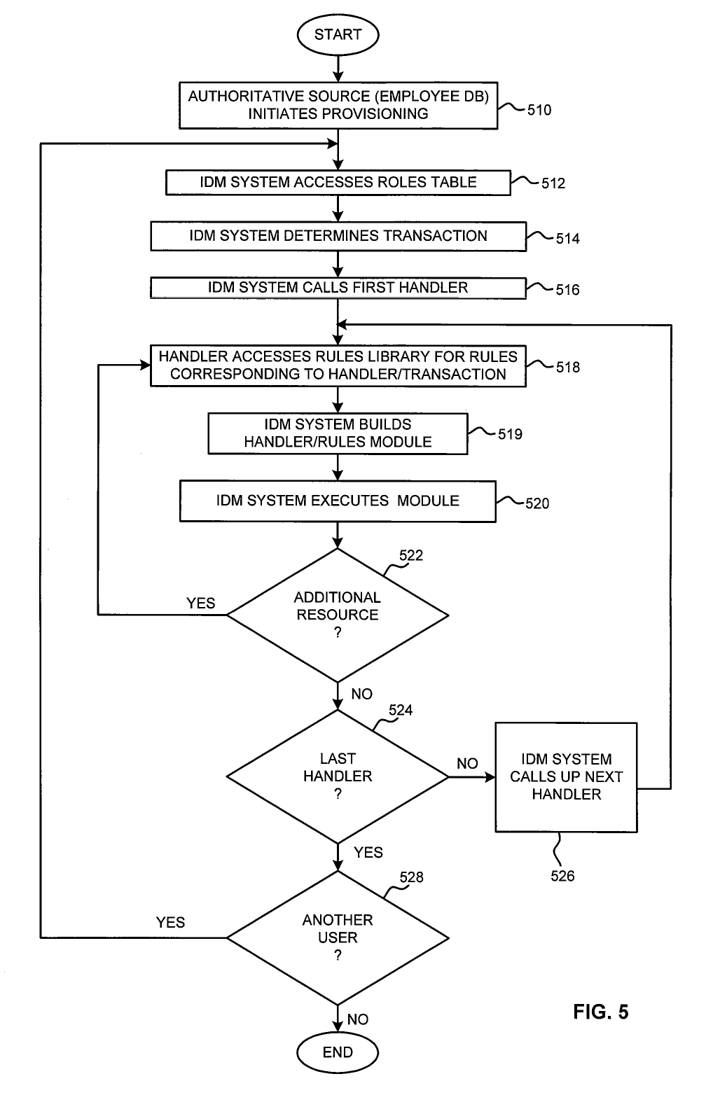

The use and interaction of the handlers 220, rules libraries 230, and the individual transaction rule subsets with each rule library will be described and better understood later in conjunction with FIGS. 5, 6 and 7.

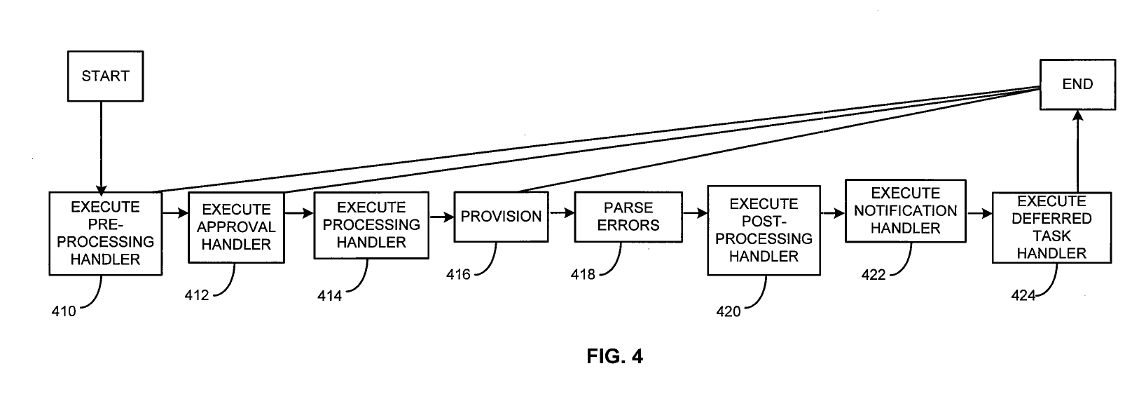

FIG. 4 illustrates the sequence of execution of the handlers. Thus, pre-processing handler is executed first (step 410), then approval handler (step 412), then processing handler (step 414), then post-processing handler (step 420), then notification handler (step 422), and finally deferred task handler (step 424). As also seen in FIG. 4, immediately after execution of the processing handler, the actual provisioning (step 416) of an application takes place, where a call or instruction is made to the application to provision the user (add or change that user's access to that application), such as by requesting that a user name or ID (created during execution of the pre-processing handler) be added or removed within the given application's authorized user table. Also seen in FIG. 4 is the parsing of errors (step 418), where any error messages generated during provisioning at the application are received, identified and then provided to the post processing handler 420. As will be understood by those skilled in the art, many possible errors can occur during provisioning. As one example, an error may occur because of rejection of a new user name that has not been properly formatted as required by the application (e.g., an application may have a unique requirement that a user name be all letters, and an error occurs if the submitted user name is improperly formatted with special characters such as #, @, &, etc.). Other errors are possible and will be likewise understood by those skilled in the art.

As further illustrated in FIG. 4, the process may end after execution of any of the handlers prior to provisioning (steps 410, 412, and 414). Such a condition will occur if tasks within one of those handlers cannot be completed. After provisioning at the application, handler execution will normally continue through all subsequent handlers notwithstanding an error or failure, with such error conditions operated on as required by the tasks within those handlers (as will be described below).

The overall process for provisioning applications and network resources using handlers and rules tables is illustrated in FIG. 5. As seen, the process is initiated (step 510) by an authoritative source providing data to the IDM system 140. In one embodiment, the authoritative source is one of the applications or resources within the network, such as an employee database. In particular, when a new employee is added to the database, the database sends the employee's identifying data to the IDM system in order to provision the employee across the needed network resources as determined by his or her title or other indicators.

The IDM system (workflow engine processor 212) then accesses the roles table to determine the resources which need to be provisioned (step 512). The IDM system also determines (step 514), based on the roles table and the data from the authoritative source, the nature of the provisioning transaction (e.g., for a new employee, a “create employee” transaction may be indicated, so that a new employee may be given access to certain resources). Then, beginning with the first resource to be provisioned, at step 516 the IDM system calls or accesses the first handler (the pre-processing handler), and that handler then calls or accesses (step 518) the rules library corresponding to the resource being provisioned and the particular rules set (see FIG. 3) within the library corresponding to the handler, and the particular rules subset for the provisioning transaction being undertaken (e.g., “create employee”).

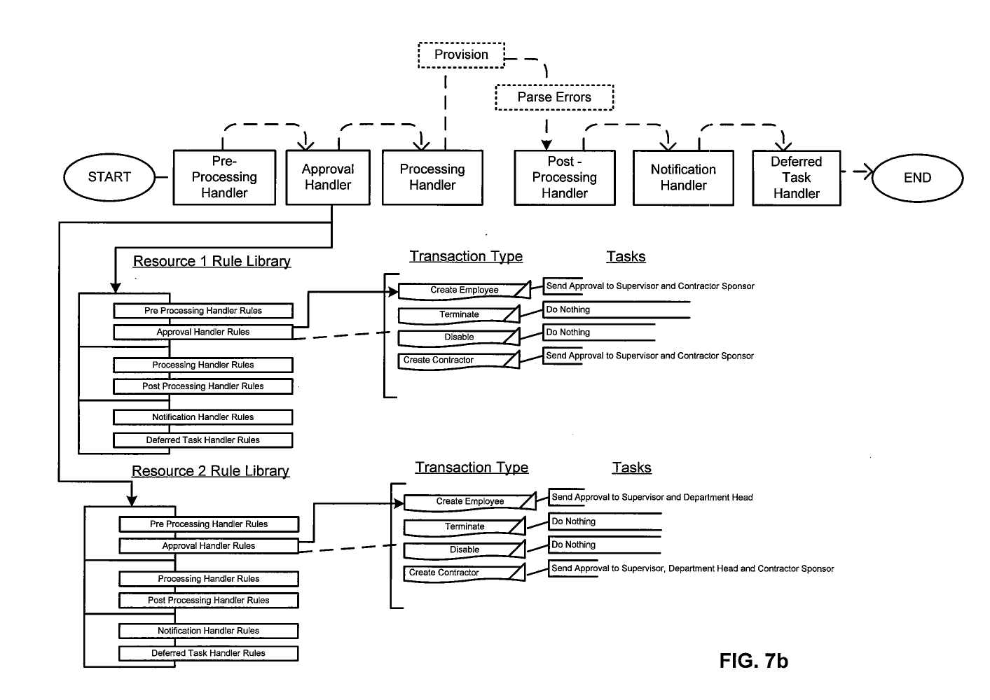

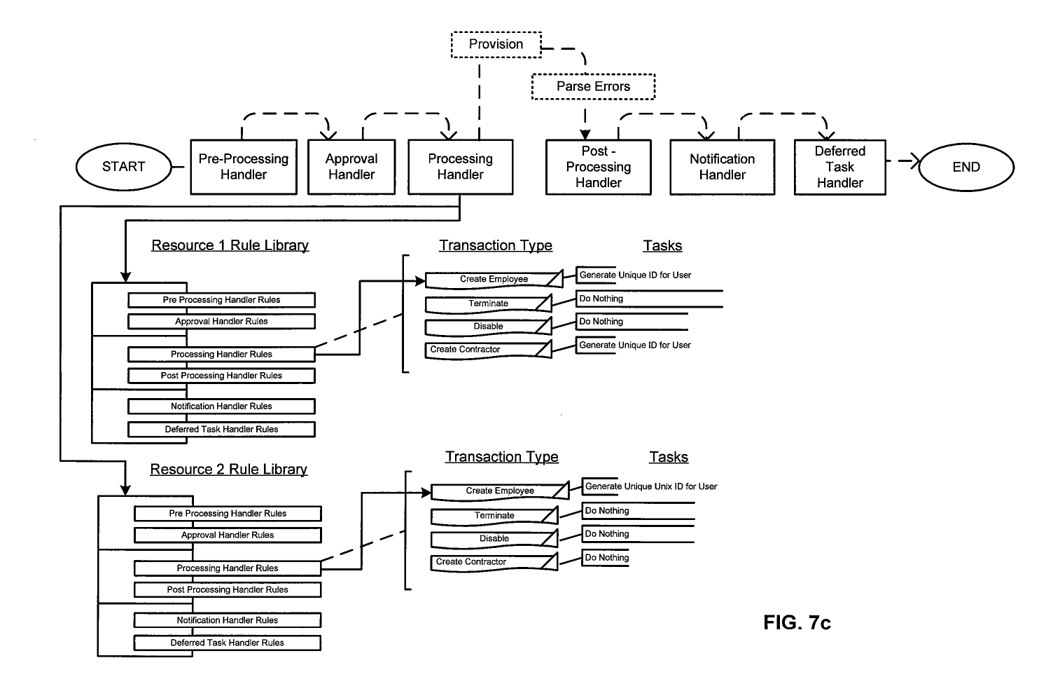

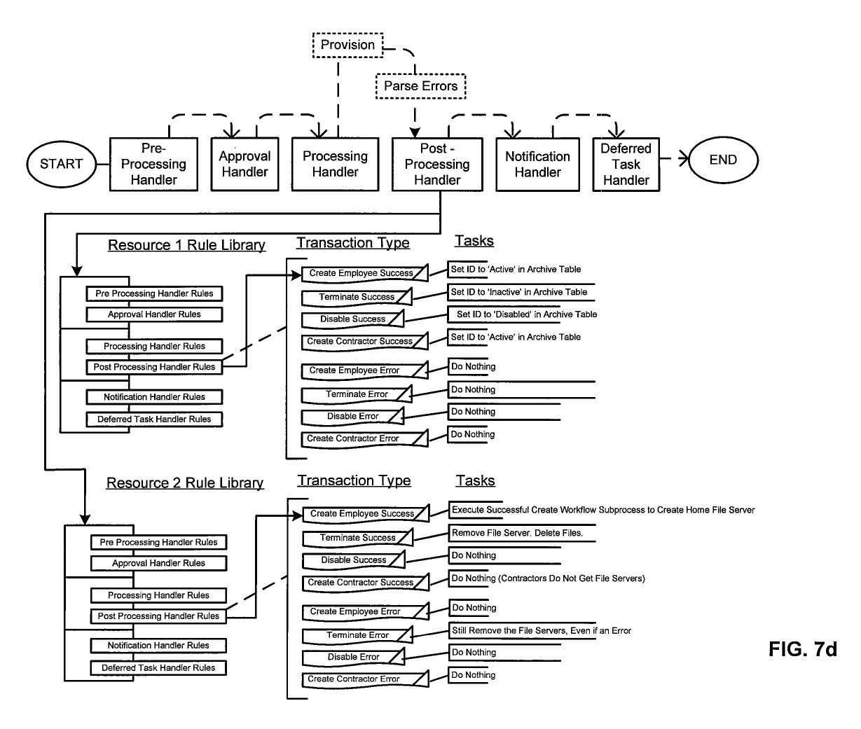

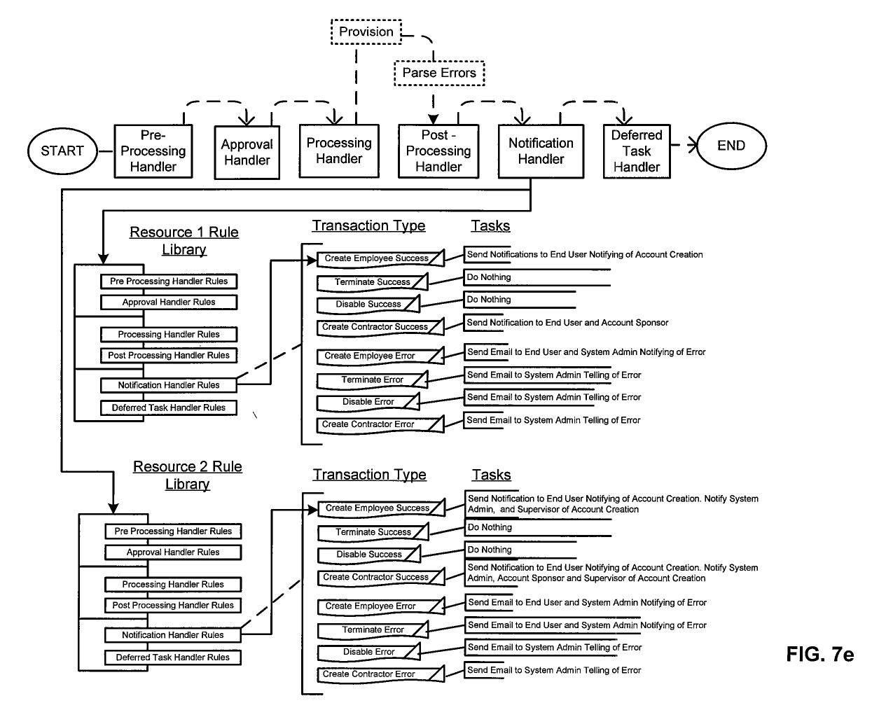

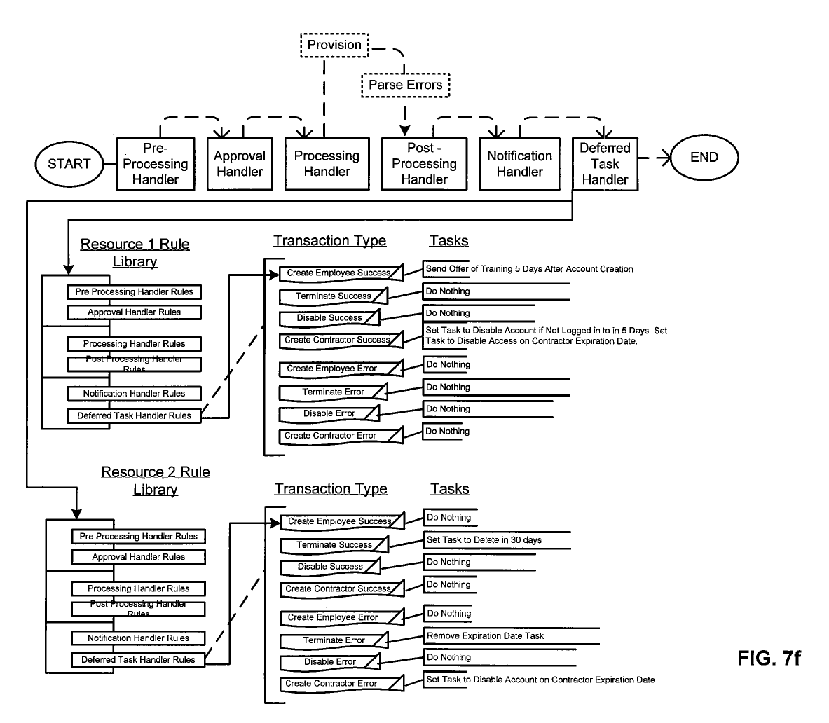

The IDM system then builds or assembles (step 519) an executable handler/rule module using the logic and code from the accessed handler and rules, and then executes the module (step 520) to perform the tasks of the handler for the given resource and transaction. The manner in which this module is built and executed will be illustrated and made more easily understood later in conjunction with the examples seen in FIGS. 7a-7f.

If the user is also being provisioned at a second resource based on the roles table (step 522), the process repeats or iterates through steps 518, 519 and 520 for the next resource (and any other additional resources) before moving on to the next handler. The IDM system then goes through the same process for the next handler (step 526) until the last handler is executed (step 524) for the given provisioning transaction. After all resources have been provisioned for the user, and if there is another user indicated by the authoritative source (step 528), the process repeats (steps 512 through 526) for that next user.

It should be noted that in FIG. 5 the iterative or repeated execution of the same handler for all resources (if there are plural resources) before moving on to the next handler (steps 518, 519 520 and 522) provides a more efficient provisioning, since calls to the applications or resources are done simultaneously at step 416 (FIG. 4). In other embodiments, calls to the application might be done serially. Further, while FIG. 5 does not illustrate the actual provisioning of the application or resource (see step 416, FIG. 4), it does occur in the illustrated process between the processing and post-processing handlers, and errors (if any) from any resource are identified and provided to the post-processing handler (as described in conjunction with FIG. 4).

In alternative embodiments of the invention, users can be provisioned in parallel rather than serially as indicated in FIG. 5 (the steps of FIG. 5 are executed simultaneously in a parallel process for multiple users).

Referring to FIGS. 6a-6f, flow diagrams show one embodiment for each of the handlers seen in FIG. 3. As should be apparent, many of the handlers execute common steps, such as accessing the rules library corresponding to the handler in order to build an executable module (of assembled code, logic and data) used by the workflow processor 212 for performing the tasks grouped within that handler.

Turning to FIG. 6a, when the pre-processing handler is executed, it first receives data inputs indicating the resource and the transaction type (step 610) based on data received at the IDM system 140 from the roles table. The handler then accesses the rules library for rules corresponding the resource, handler and transaction type (step 612) which define the specific pre-processing tasks to be performed. The tasks are built or incorporated into an executable handler/rules module (step 614), which is provided to the workflow processor for execution (step 616). The handler then calls the next handler (approval), unless there is an additional resource to be provisioned (in which case, the steps are repeated).

In FIG. 6b, when the approval handler is executed, it receives the appropriate data inputs (e.g., resource, transaction type) from the pre-processing handler (step 620), accesses the rules library for rules corresponding the resource, handler and transaction type (step 622) which define the specific approval tasks to be performed including, in this case, approval contact information, email template, content and so forth. The tasks are built or incorporated into an executable handler/rules module (step 624), which will include for this handler (among other things) the format and transmission media to be used for requesting approvals. The module is provided to the workflow processor for execution (step 626). As part of this handler, the workflow engine may also check for approval replies granting or denying the approval request (step 628). The handler then calls the next handler (processing), unless there is an additional resource to be provisioned. It should be noted that if an approval request is denied, such condition is provided to the next handler (processing), to be acted upon as one of the tasks.

In FIG. 6c, when the processing handler is executed, it receives the appropriate data inputs (e.g., resource, transaction type, approval granted/denied) from the approval handler (step 630), accesses the rules library for rules corresponding the resource, handler and transaction type (step 632) which define the specific processing tasks to be performed, including data to be used in accessing the application via a call or request in order to provision the user. The tasks are built or incorporated into an executable handler/rules module (step 634), which is provided to the workflow processor for execution (step 636). The workflow engine then calls the application to provide provisioning data concerning the user (step 638).

In FIG. 6d, when the post-processing handler is executed, it receives from the application (step 640) a message regarding the success of failure (error) of the provisioning at the application, and also receives data inputs (e.g., resource, transaction type) from the processing handler (step 642). The handler accesses the rules library for rules corresponding the resource, handler and transaction type (step 644) which define the specific post-processing tasks to be performed, builds or incorporates those tasks into an executable handler/rules module (step 646), which is provided to the workflow processor for execution (step 648). The handler then calls the next handler (notification), unless there is an additional resource to be provisioned.

In FIG. 6e, when the notification handler is executed, it receives the appropriate data inputs (e.g., resource, transaction type) from the post-processing handler (step 650), accesses the rules library for rules corresponding the resource, handler and transaction type (step 652) which includes tasks and data objects such as the specific recipient(s) to be inserted into notifying emails, the content of the email subject line, and specific identifying information to be put in the notifying email identifying the application and the access rights granted (read only, unlimited access, etc.). The tasks are built or incorporated into an executable handler/rules module (step 654), which will include (among other things) for this handler the format and transmission media to be used for providing notifications The module is provided to the workflow processor for execution in order to send the notifications (step 656). The handler then calls the next handler (deferred task), unless there is an additional resource to be provisioned.

If FIG. 6f, when the deferred task handler is executed, it receives the appropriate data inputs (e.g., resource, transaction type) from the notification handler (step 660), accesses the rules library for rules corresponding the resource, handler and transaction type (step 662) which define the specific deferred tasks to be performed, including calculating or setting times and/or dates for the performance of the deferred tasks (step 664). The tasks are built or incorporated into an executable handler/rules module (step 666), which is provided to the workflow processor for execution (step 668). The provisioning process ends after this handler step, unless there is an additional resource to be provisioned.

FIGS. 7a through 7f illustrate an example of the operational flow between the handlers 220 and rules libraries 230. This particular example assumes a circumstance where a new employee has joined the enterprise, and is authorized (as defined by roles table 240) to have complete access (as a new employee) to only two resources (Resource 1 and Resource 2). This particular provisioning transaction is termed “Create Employee.”

When the pre-processing handler is executed (FIG. 7a), it first calls the “Resource 1 Rule Library”, selects the “Pre-Processing Handler Rules” set and, since the transaction type is “Create Employee,” it selects the “Create Employee” rule subset. This rule subset has one task to be performed within the pre-processing handler given this resource and this transaction type, namely the illustrated task of “Reserve ID in ID archives” This particular tasks refers to the IDM system establishing a new ID for the new employee and reserving it in a table within the IDM system. The handler then calls the library for the second resource (“Resource 2 Rule Library”), selects the “Pre-Processing Handler Rules” set, and since the transaction type is “Create Employee”, it selects the “Create Employee” rule subset. This rule subset has no tasks to be performed. Thus, if there are no other resources, controls moves to the approval handler.

Before leaving FIG. 7a, it should be noted that other tasks are illustrated for different transaction types. Thus, if for Resource 1 the transaction type had been “Terminate,” indicating that the user's access to Resource 1 was being removed or deleted, the task would have been “Set ID to ‘pending terminate’ in archive,” meaning that the existing ID for the user in the IDM table would be so marked as part of one task in terminating the employee's access. There are two other transaction types illustrated but not used in this example, namely “Disable” (referring to a user account that is to be disabled as part of the provisioning process), and “Create Contractor” (referring to a new user that is a non-employee being given new access to a resource). This last mentioned transaction type is useful because tasks associated with a contractor may be different when creating or terminating an account, such as a business requirement that contractor access to a resource being more limited than employee access (e.g., contractor access to confidential data being blocked).

It should also be noted that although there is illustrated, for purposes of simplifying the description, only one task (or in some cases no task) for transaction types, there could be any number of tasks. In some cases, depending on the transaction type and the needs of the enterprise, many tasks might be required.

FIG. 7b is similar to FIG. 7a, except that the approval handler is being executed for the transaction type “Create Employee”. For Resource 1, the task performed is “Send Approval to Supervisor.” For Resource 2, the task performed is “Send Approval to Supervisor and Department Head.”

In FIG. 7c, the processing handler is executed for the transaction type “Create Employee”, with the task for Resource 1 being “Generate Unique ID for User” (referring to a task where the previously reserved user named is reformatted if necessary to be unique from any other user name before being sent to the resource), and the task for Resource 2 being “Generate a Unique Unix ID for User” (the user ID needs to be reformatted for use in Resource 2, because it is a Unix-based system).

In FIG. 7d, the post-processing module is executed (after provisioning at the resource, and parsing of errors, if any). Note here that the number of transaction types has changed from four to eight, to accommodate errors (if any) returned by the application. Thus the transaction types are “Create Employee Success” (there was no error message returned in provisioning at the application), “Terminate Success,” “Delete Success,” “Create Contractor Success,” “Create Employee Error” (there was an error message returned in provisioning at the application), “Terminate Error,” “Delete Error,” and “Create Contractor Error.” Since provisioning at both applications was successful, the transaction type is now “Create Employee Success.”

In FIG. 7e, the notification handler is executed for the transaction type “Create Employee Success,” with the task for Resource 1 being “Send Notification to End User Notifying of Account Creation,” and the two tasks for Resource 2 being “Send Notification to End User Notifying of Account Creation” and “Notify System Admin and Supervisor of Account Creation”.

Finally in FIG. 7f , the deferred task handler is executed for the transaction type “Create Employee Success,” with the task for Resource 1 being “Send Offer of Training 5 days After Account Creation”, and the task for Resource 2 being “Do Nothing” (no tasks are being performed).

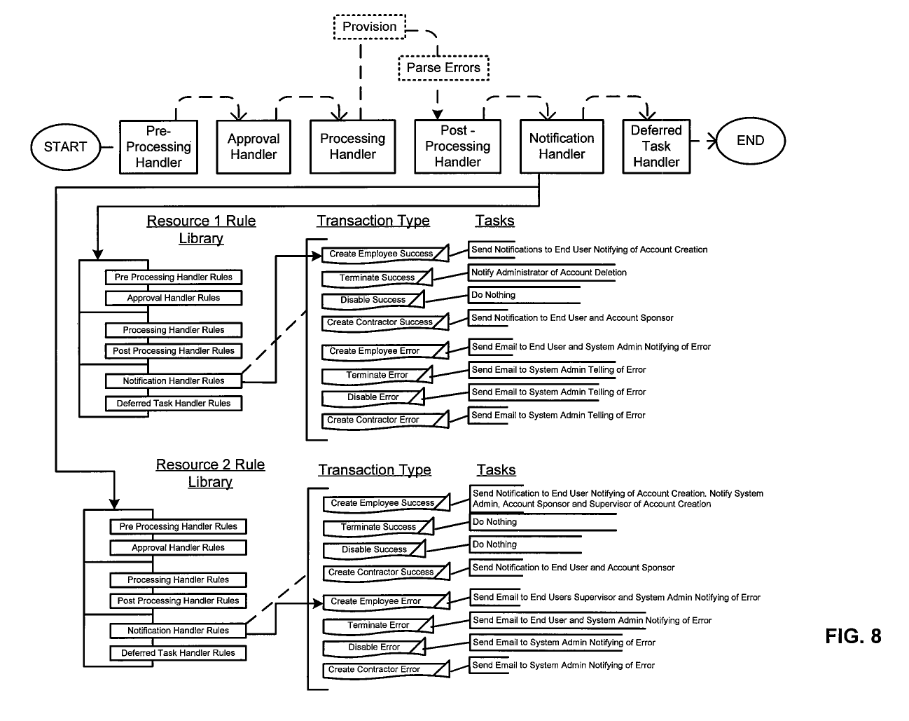

FIG. 8 is similar to FIG. 7e (execution of notification handler), but illustrates a condition where for Resource 1 the provisioning was successful at the application, but for Resource 2 it failed and a message error was received. Note that the transaction type for Resource 2 is now “Create Employee Error,” and the rule subset now provides logic for the resulting task “Send email to end User's Supervisor and System Admin Notifying of Error.”

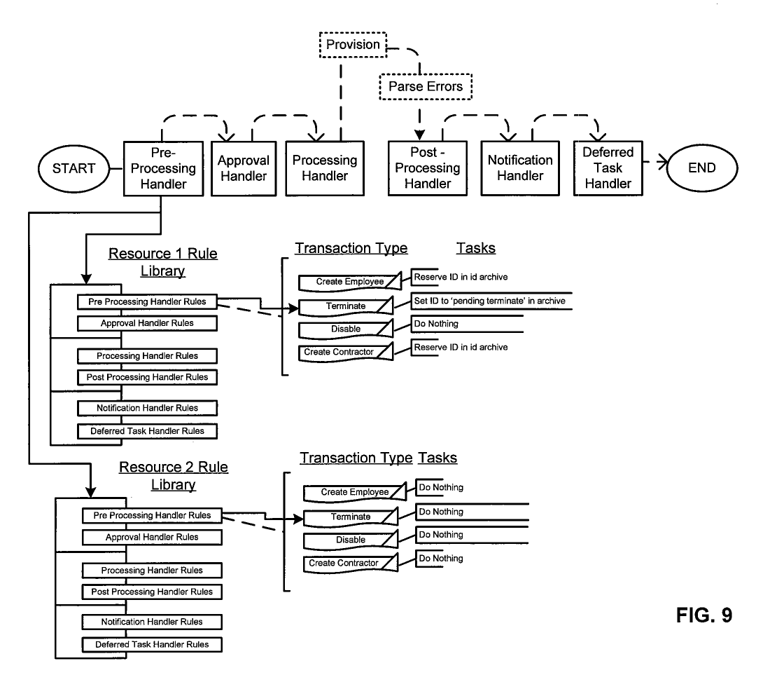

FIG. 9 is similar to FIG. 7a (execution of pre-processing handler), but illustrates an example where there is a different transaction type. In this instance, and employee is terminated and access to various resources is now being removed. The transaction type is “Terminate,” and the resulting task is “Set ID to ‘pending termination’ in archives”

While a detailed description of presently preferred embodiments of the invention has been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. In a network having a plurality of system resources, an identity management system for managing user access to the system resources, the system comprising:
a processor for performing access management transactions, each transaction having a corresponding transaction type;
a memory device;
a plurality of handlers stored in the memory device, each handler defining one or more handler tasks common to each of the plural system resources when managing access to the resources; and
a plurality of rules libraries stored in the memory device, each library corresponding to one resource and defining rules used with the handler tasks, each rule associated with a transaction type;
wherein the processor performs an access management transaction for a resource by accessing each handler, accessing the rules library corresponding to that resource, and executing handler tasks using rules in the library associated with the transaction type corresponding to that transaction.

2. The system of claim 1, wherein the handler tasks are each associated with handlers so that the access management transaction is completed by accessing the handlers in sequential order.

3. The system of claim 2, wherein the access management transaction is for a single user and plural resources, wherein the handler tasks of each handler are executed for each of the plural resources for that single user before executing the next handler in the sequence.

4. The system of claim 1, wherein the handlers are chosen from a group consisting of:
a pre-processing handler having tasks to be performed prior to obtaining approval for changing a user's access to a resource;
an approval handler having tasks relating to approval for changing a user's access to a resource;
a processing handler having tasks to be performed after obtaining approval but before issuing a request to a resource for changing a user's access;
a post-processing handler having tasks to be performed after a request to a resource for changing a user's access;
a notification handler having tasks for notifying others of a change in the user's access; and
a deferred task handler having tasks to be performed after execution of the access management transaction.

5. The system of claim 1, wherein the handlers comprise, in order:
a pre-processing handler having tasks to be performed prior to obtaining approval for changing a user's access to a resource;
an approval handler having tasks relating to approval for changing a user's access to a resource;
a processing handler having tasks to be performed after obtaining approval but before issuing a request to the resource for changing a user's access;
a post-processing handler having tasks to be performed after a request to the resource for changing a user's access;
a notification handler having tasks for notifying others of a change in the user's access; and
a deferred task handler having tasks to be performed after execution of the access management transaction;
wherein the processor accesses the handlers sequentially in order to perform the access management transaction.

6. The system of claim 1, wherein transaction types comprise:
a create new employee transaction, wherein a new employee is being given access as a new user to a resource; and
a create new contractor transaction, wherein a non-employee is being given access as a new user to a resource.

7. The system of claim 6, wherein the transaction types further comprise:
a terminate transaction, wherein a user's access to a resource is being made inactive; and
a delete transaction, wherein a user's ID for accessing a resource is being deleted and is no longer available for use.

8. The network of claim 1, wherein the identity management system is centralized for managing user access to all of the plurality of system resources, wherein the handlers and rules libraries are stored in the memory device at the centralized identity management system, and wherein the handlers and rules libraries are each separate files, so that if a resource is removed from the network and no longer needs access management, the rules library corresponding to that resource can be removed as a file without the need for modifying the handlers.

9. A computerized method for managing user access to a plurality of resources in an enterprise network, comprising:
providing an identity managed (IDM) system for centrally managing access to the resources by users within the network, the IDM system including a workflow processor for executing access management transactions and a storage device for storing handlers and rules libraries;
organizing the handlers so each handler defines one or more tasks associated with a predefined process common to all of the resources when managing access to the resource;
organizing the rules libraries so that a library is associated with each resource, the library having rules for managing access to that resource; and
organizing each rule library into access management transaction rules, each transaction rule associated with an access management transaction and used with the handlers for performing tasks as part of the predefined process of one handler;
wherein an access management transaction for a resource is executed by the workflow processor by accessing each handler, accessing the rules library associated with that resource, accessing the set of rules within the library for the transaction being executed, and then using the handler with the set of rules for the transaction.

10. The method of claim 9, wherein the handlers comprise:
a pre-processing handler defining tasks to be performed prior to obtaining approval for changing a user's access to a resource;
an approval handler defining tasks relating to approval for changing a user's access to a resource;
a processing handler defining tasks to be performed after obtaining approval but before issuing a request to a resource for changing a user's access;
a post-processing handler defining tasks to be performed after a request to a resource for changing a user's access;
a notification handler defining tasks for notifying interested parties of the change in a user's access; and
a deferred task handler defining tasks to be performed after execution of the access management transaction.

11. The method of claim 10, wherein the access management transactions comprise:
a create new employee transaction, wherein a new employee is being given access as a new user to a resource; and
a create new contractor transaction, wherein a non-employee is being given access as a new user to a resource.

12. The method of claim 11, wherein the access management transactions further comprise:
a terminate transaction, wherein user's access to a resource is being made inactive; and
a delete transaction, wherein a user's ID for accessing a resource is being deleted and is no longer available for use.

13. The method of claim 9, wherein the execution of an access management transaction by the workflow processor is initiated in response to data from an authoritative source.

14. The method of claim 13, wherein the authoritative source is one of the resources.

15. The method of claim 14, wherein the authoritative source is an employee data base that has been updated with a new user.

16. The method of claim 14, wherein the workflow processor accesses a roles table in response to the data from the authoritative source.

17. The method of claim 16, wherein the roles table maintains a list of authorized resources associated with a user.

18. In a network having plurality of users, a plurality of system resources, and a central identity management system for managing user access to the system resources, a method for managing access to each system resource, the method comprising:
providing a plurality of handlers at the identity management system, each handler associated with a predefined process that is common to each of the system resources when managing user access to that system resource, with each process associated with one or more individual tasks that are executed in order to complete the predefined process; and
executing the tasks associated with each of the handlers;
so that the same plurality of handlers may be used at the central identity management system for managing access to all of the resources, without having a separate set of tasks associated with each resource that are executed independently of the handlers.

19. The method of claim 18, further comprising:
providing a plurality of rules libraries, each library associated with one resource, and having rules used with the handlers when managing access at the associated resource.
